(19) United States
(12) Patent Application Publication
(10) Pub. No.: US 2023/0192430 A1
(43) Pub. Date: Jun. 22, 2023

(54) LOAD STRAP RETRACTING DEVICE

(71) Applicant: Frank Noe, Oregon City, OR (US)

(72) Inventor: Frank Noe, Oregon City, OR (US)

(21) Appl. No.: 17/555,373

(22) Filed: Dec. 18, 2021

(51) Int. Cl. B65H 18/10

(52) U.S. Cl. CPC B65H 18/10

(57) ABSTRACT

A Load Strap Retracting Device for rolling a strap after use of securing a load in a tractor-trailer is presented. The Load Strap Retracting Device is useful reducing the time to roll a load strapping device as well as reducing the effort required to roll the load strapping device after use. Also, the Load Strap Retracting Device can be use in an existing hole in an existing load strap bracket winch system. Furthermore, the Load Strap Retracting Device is cost efficient and time efficient.

### FIELD OF THE INVENTION

This invention relates to loads in a tractor-trailer. More particularly, it relates to winding of straps after using the straps for securing a load in a tractor-trailer.

### BACKGROUND

A semi-tractor-trailer truck, also known as simply a semi-trailer truck, semi-tractor truck, semi-tractor-trailer or tractor-trailer truck, is the combination of a tractor unit and one semi-trailer or more to carry freight.

A semi-trailer attaches to the tractor with a type of hitch called a fifth-wheel. The tractor unit typically has two or three axles; those bunt for hauling heavy-duty commercial-construction machinery may have as many as five, some often being lift axles.

The most common tractor-cab layout has a forward engine, one steering axle, and two drive axles. The fifth-wheel trailer coupling on most tractor trucks is movable fore and aft, to allow adjustment in the weight distribution over its rear axle(s).

Ubiquitous in Europe, but less common in North America since the 1990s, is the cabover engine configuration, where the driver sits next to, or over the engine. With changes in the US to the maximum length of the combined vehicle, the cabover was largely phased out of North American over-the-road (long-haul) service by 2007. Cabovers were difficult to service; for a long time, the cab could not be lifted on its hinges to a full 90-degree forward tilt, severely limiting access to the front part of the engine.

The cargo trailer usually has tandem axles at the rear, each of which has dual wheels, or eight tires on the trailer, four per axle. In the US it is common to refer to the number of wheel hubs, rather than the number of tires; an axle can have either single or dual tires with no legal difference. The combination of eight tires on the trailer and ten tires on the tractor is what led to the moniker eighteen-wheeler, although this term is considered by some truckers to be a misnomer (the term “eighteen-wheeler” is a nickname for a five-axle over-the-road combination). Many trailers are equipped with movable tandem axles to allow adjusting the weight distribution.

To connect the second of a set of doubles to the first trailer, and to support the front half of the second trailer, a converter gear known as a “dolly” is used. This has one or two axles, a fifth-wheel coupling for the rear trailer, and a tongue with a ring-hitch coupling for the forward trailer. Individual states may further allow longer vehicles, known as “longer combination vehicles” (or LCVs), and may allow them to operate on roads other than Interstates.

Load securing, also known as cargo securing, is the securing of cargo for transportation.

Blocking and bracing: Blocking and bracing is a load securernent method using lumber and metal bars to reduce or inhibit front to rear shifting of freight/cargo. Plastic forms are also used.

Fasteners: Depending on the type of load and the particular vehicle, large bolts and nails may be used. These may be on the load itself or on wood blocks used to brace the load. Fasteners rely on the constructional strength of the Cargo Transport Unit (CTU).

Dunnage: Dunnage for securing cargo includes scrap wood to fill voids in cargo, wooden boards forming “cribs”, blocking and bracing, and modern mechanical, spring-loaded post-and-socket systems, Dunnage segregates cargo in the hold and prevents shifting of the cargo in response to ship or vehicle motions. Dunnage stresses the constructional strength of the Cargo Transport Unit (CTU).

Strapping: Strapping is used to create a transportable unit. Types of strapping include steel, polyester, polypropylene, nylon, paper, and composites. The type of strap used depends on the requirements, for example, strength, elasticity, ability to withstand various environments, ease of use, safety, and cost. All types of tensioned strapping, particularly steel, need to be handled carefully because of potential injury.

Lashing: Lashing is the securing of cargo for transportation with the goal of minimizing shifting. Items used for lashing include ropes, cables, wires, chains, strapping, and nets. These items are anchored to the Cargo Transport Unit (CTU) and tensioned against the cargo. Another form of lashing used four devices attached to the top of each corner of a container

Dunnage bags: Whereas strapping and lashing is often used to secure odd-shaped cargo such as machinery, structures, and vehicles. Dunnage bags are mostly used for homogeneous shaped cargo such as food & beverage products, electronics and appliances and roll paper. Often, strapping/lashing and dunnage bags are used in combination to secure chemical products. Dunnage Bags are not approved for rail transportation of hazardous materials in the United States.

Dunnage bags, also known as air bags, were introduced some 40 years ago as a convenient, fast and cost-effective alternative to secure and stabilize cargo in ISO sea containers, closed rail cars, trucks and (ocean-going) vessels. The purpose of dunnage bags is often misunderstood when they are considered as a void filler only to prevent lateral movement of cargo. When properly applied however, dunnage bags form a 3-dimensional bulkhead of the cargo itself preventing both lateral and longitudinal movement. Dunnage bags rely on the Cargo Transport Unit (CTU) construction, which is to be noted when planning. All cargo movements will therefore stress the construction.

Tie downs: Heavy loads are sometimes secured to vehicles with tie down straps, heavy duty strapping, or tensioned chains, Heavy objects with round shape like paper rolls can be difficult to secure. Strong woven tarpaulins manufactured to this purpose can then be used. They work in several ways: first of all, the ends of the tarpaulin can be used to block the horizontal movement in longitudinal direction as direct spring lashing, secondly the mid part of the tarpaulin work as a top over lashing where the surface pressure caused by tensioning the strapping is evenly distributed over the entire load and thirdly the tarpaulin forms itself according to the cargo form and prohibits horizontal movements of single cargo items.

There are numerous issues that arise when using strapping, which is the most commonly used method to secure loads in the tractor-trailers. However, as with most mechanical items, they must be properly used to be effective. Should they not be tight enough, the load can move about and perhaps even rail from the truck. Should they be tightened too tight, they may damage the load or cause the strap to excessively wear and break. Most drivers use a bar to tighten such load straps in their bracket. This is also a time-consuming process as the bar must be repeatedly inserted and removed in the tightening process. This excessive time may cause many users to not properly apply the straps in an effort to save time. Also, after unloading a truck, all loose straps must be wound up on their reel, which, once again, takes a good deal of time.

In light of the foregoing, it would be desirable to devise an improved patient transfer device that provided more flexibility in deployment while still being easy to operate and maneuver. It would be further advantageous if the device were more comfortable for the patient, yet could still maintain the patient in a stabilized manner during transport.

### BRIEF DESCRIPTION OF THE DRAWINGS

FIG. 1A is an illustrated view of a Load Strap Retracting Device.

FIG. 1B is an illustrated view of a holding device of the Load Strap Retracting Device shown in FIG. 1A.

FIG. 2 is an illustrated view of a load strap being placed in the Load Strap Retracting Device shown in FIG. 1A.

FIG. 3 is an illustrated first time point of a rolling of the load strap shown in FIG. 2 with the Load Strap Retracting Device shown in FIG. 1A.

FIG. 4 is an illustrated second time point of a rolling of the load strap shown in FIG. 2 with the Load Strap Retracting Device shown in FIG. 1A.

FIG. 5 is an illustrated a finished rolling of the load strap shown in FIG. 2 with the Load Strap Retracting Device shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

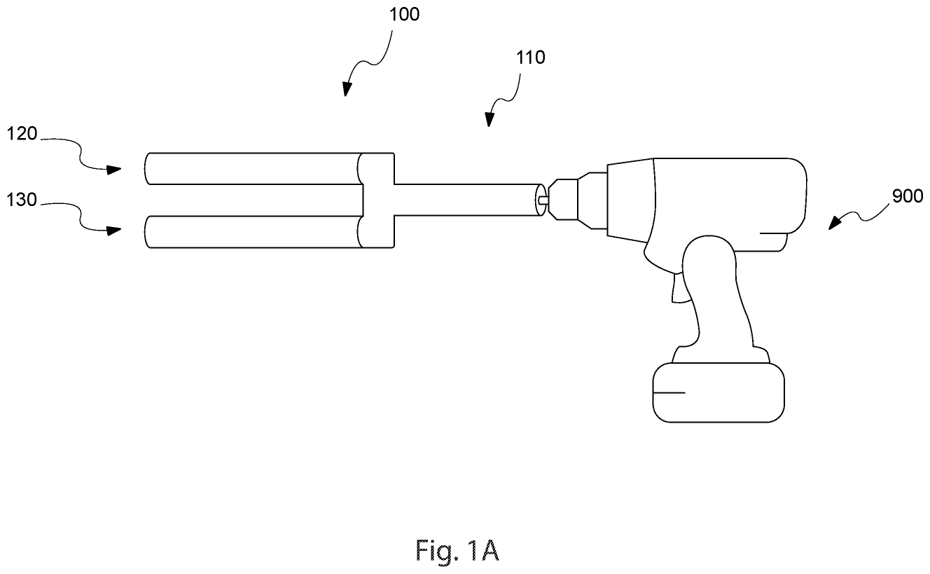

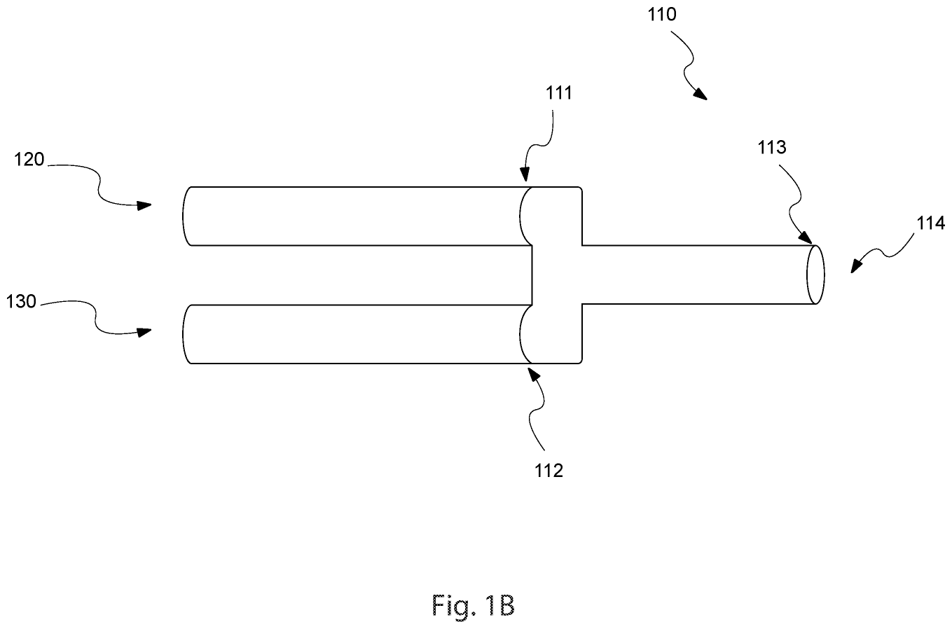

Referring to FIG. 1A and FIG. 1B, a Load Strap Retracting Device 100 for rolling a strap after use of securing a load in a tractor-trailer is presented. The Load Strap Retracting Device 100 is useful reducing the time to roll a load strapping device as well as reducing the effort required to roll the load strapping device after use. Also, the Load Strap Retracting Device 100 can be use in an existing hole in an existing load strap bracket winch system. Furthermore, the Load Strap Retracting Device 100 is cost efficient and time efficient.

The Load Strap Retracting Device 100 is preferably made of a steel material, however other materials are hereby contemplated, including, but not limited to, poly-vinyl chloride (PVC), aluminum, etc. The Load Strap Retracting Device 100 is preferably twelve (12) inches in length, however other lengths are hereby contemplated, including, but not limited to, ten (10) inches, fifteen (15) inches, etc.

The Load Strap Retracting Device 100 has an elongated end 110 and a plurality of arms 120, 130. The elongated end 110 is preferably a “J” shape, however other shapes are hereby contemplated, including, but not limited to, rectangular, oblong, etc. A first of the arms 120 is coupled to a first end 111 of the elongated end 110. A second of the arms 130 is coupled to a second end 112 of the elongated end 113. A third end 113 of the elongated end 110 has an opening 114. The opening 114 of the elongated end 110 is preferably of a size to couple to a three-eighths (⅜) inch or larger drill 900. The drill 900 is preferably cordless however any drill contemplated by a person of skill in the art is hereby contemplated in this application.

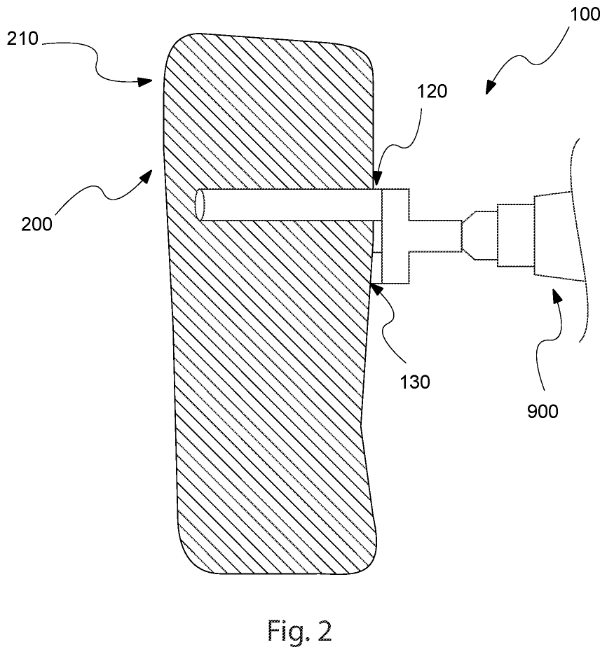

Moving now to FIG. 2, an illustrated view of a first end 210 of a load strap 200 is threaded between the first of the arms 120 and the second of the arms 130. The drill 900 is coupled to the third end 113 of the elongated end 110 of the Load Strap Retracting Device 100.

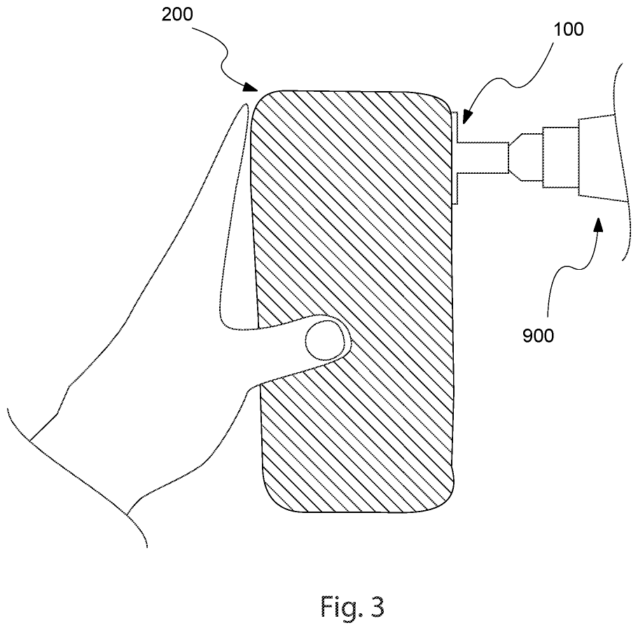

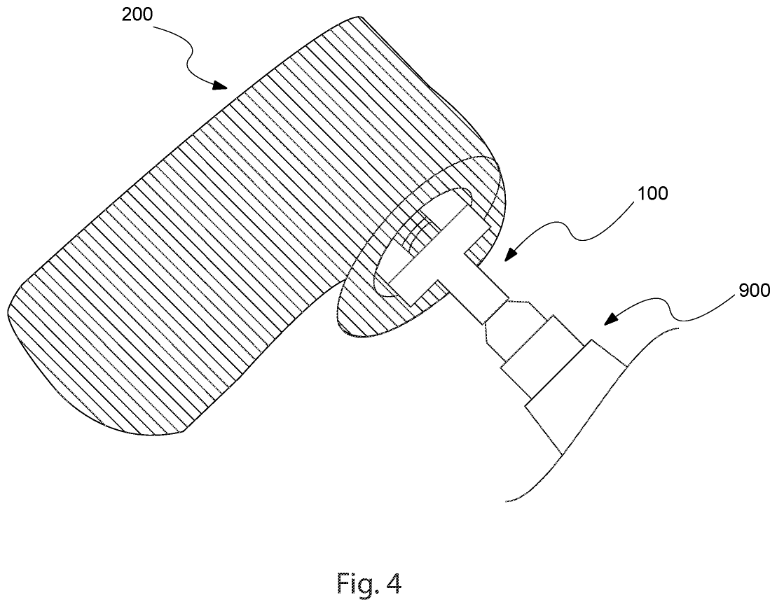

Referring now to FIG. 3 and FIG. 4, the load strap 200 is shown in various stages of being rolled by the Load Strap Retracting Device 100 coupled to the drill 900 is shown.

The load strap 200 is rolled by the Load Strap Retracting Device 100 coupled to the drill 900. The drill 900 is actuated to turn the Load Strap Retracting Device 100 in a clockwise direction such that the load strap 200 is coiled or rolled into a neat, storage area friendly roll that can be easily reused and unrolled.

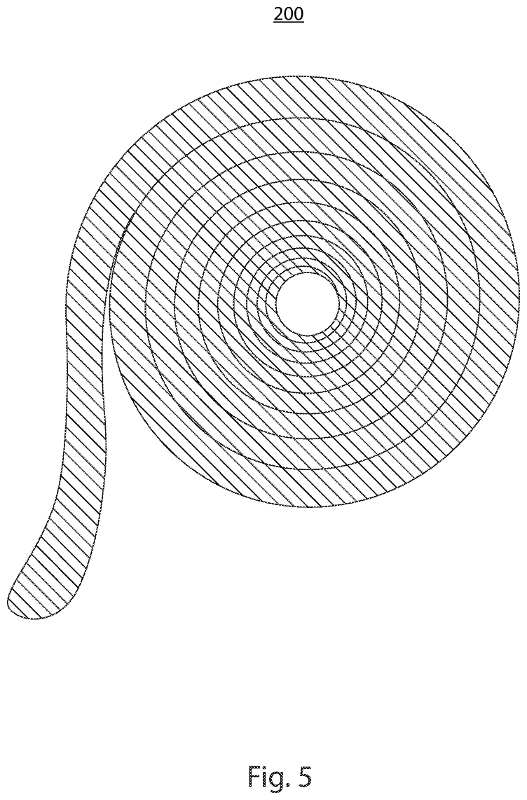

Now referring to FIG. 5, is an illustrated view of a finished rolled load strap 200. In FIG. 5, the Load Strap Retracting Device 100 has completed rolling the load strap 200. The rolled load strap 200 has been removed from the Load Strap Retracting Device 100 and is ready to stored or to be used to secure a load on another or the same tractor-trailer.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A load strap retracting device for rolling a load strap, the device comprising:
an elongate bend, the elongated end having a first end, a second end and a third end;
a plurality of arms, a first of the arms being coupled to the first end of the elongated end, a second of the arms being coupled to the second end of the elongated end; and
a hole, the hole being on the third end of the elongated end, wherein the third end of the elongated body is removably coupled to a drill.

2. The load strap retracting device of claim 1, wherein the load strap retracting device is made of a steel material.

3. The load strap retracting device of claim 1, wherein the load strap retracting device has a length of twelve (12) inches.

4. The load strap retracting device of claim 1, wherein the first of the arms is separated by space from the second of the arms.

5. The load strap retracting device of claim 1, wherein the third end of the elongated end is a size to be accommodated by a three-eights (⅜) inch drill.
